(19) United States
(12) Patent Application Publication
(10) Pub. No.: US 2010/0176283 A1
(43) Pub. Date: Jul. 15, 2010

(54) Sensor and method for determining an angular position of a rotor using an elongated member

(76) Inventors: Vladimir Karasik, Walled Lake, MI (US); David Wiechmann, West Bloomfield, MI (US)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/321,119

(22) Filed: Jan. 15, 2009

(51) Int. Cl. G01D 5/347

(52) U.S. Cl. 250/231.18

(57) ABSTRACT

A sensor for determining an angular position of a rotor comprises an elongated member for attachment to the rotor for lengthwise movement in response to rotation of the rotor. The elongated member has a length and includes indicia identifying predetermined designated segments along the length. A field source generates a field adjacent to a selected portion of the length of the elongated member. A field effect detector detects at least one of the indicia associated with the selected portion of the length of the elongated member in response generation of the field adjacent the selected portion. The detected one of the indicia identifies at least one of the designated segments. The identified designated segment is functionally related to the angular position of the rotor.

### TECHNICAL FIELD

The present invention relates to a sensor and method for determining an angular position of a rotor and, more specifically, to a sensor and method for determining an angular position of a steering wheel of a vehicle.

### BACKGROUND OF THE INVENTION

Steering angle sensors are used to determine the angular position of a steering wheel of a vehicle. A steering angle sensor may include a code disk that rotates with the steering wheel. The code disk is at least partially transparent and has an optical coding. A light source is directed toward the code disk. A photosensitive receiver receives the light that passes through the code disk.

### SUMMARY OF THE INVENTION

The present invention is directed to a sensor and method for determining an angular position of a rotor and, more specifically, to a sensor and method for determining an angular position of a steering wheel of a vehicle.

In accordance with one representative embodiment of the invention, a sensor for determining an angular position of a rotor comprises an elongated member for attachment to the rotor for lengthwise movement in response to rotation of the rotor. The elongated member has a length and includes indicia identifying predetermined designated segments along the length. A field source generates a field adjacent to a selected portion of the length of the elongated member. A field effect detector detects at least one of the indicia associated with the selected portion of the length of the elongated member in response to generation of the field adjacent the selected portion. The detected one of the indicia identifies at least one of the designated segments. The identified designated segment is functionally related to the angular position of the rotor.

In accordance with a second representative embodiment of the invention, a sensor for determining an angular position of a rotor comprises an elongated member for attachment to the rotor for lengthwise movement in response to rotation of the rotor. The elongated member has a length and includes indicia identifying predetermined designated segments along the length. A light source illuminates a selected portion of the length of the elongated member. A detector detects at least one of the indicia associated with the selected portion of the length of the elongated member in response to illumination of the selected portion by the light source. The detected one of the indicia identifies at least one of the designated segments. The identified designated segment is functionally related to the angular position of the rotor.

In accordance with a third representative embodiment of the invention, an apparatus for determining an angular position of a rotor comprises an elongated member for attachment to the rotor for lengthwise movement in response to rotation of the rotor. The elongated member has a length and includes indicia representing digital bits to identify predetermined designated segments along the length. Each designated segment is identified by a code word comprising a plurality of digital bits. A detector detects the digital bits from a selected portion of the length of the elongated member. The selected portion of the length is functionally related to the angular position of the rotor. The detector determines values of the detected digital bits, monitors the determined values to recognize at least one code word, and determines the angular position of the rotor based upon the at least one recognized code word.

In accordance with a fourth representative embodiment of the invention, a method for determining an angular position of a rotor comprises the step of attaching an elongated member to the rotor for lengthwise movement in response to rotation of the rotor. The elongated member has a length and includes indicia identifying predetermined designated segments along the length. The method also comprises the step of generating a field adjacent to a selected portion of the length of the elongated member. The selected portion of the length is functionally related to the angular position of the rotor. The method further comprises the step of detecting at least one of the indicia associated with the selected portion of the length of the elongated member in response to generation of the field adjacent to the selected portion. The method still further comprises the steps of identifying at least one of the designated segments from the detected at least one of the indicia, and determining the angular position of the rotor based upon the identified at least one of the designated segments.

In accordance with a fifth representative embodiment of the invention, a method for determining an angular position of a rotor comprising the step of attaching an elongated member to the rotor for lengthwise movement in response to rotation of the rotor. The elongated member has a length and includes indicia representing digital bits to identify predetermined designated segments along the length. Each designated segment is identified by a code word comprising a plurality of digital bits. The method also comprises the step of detecting the digital bits from a selected portion of the length of the elongated member, which selected portion is functionally related to the angular position of the rotor. The method further comprises the steps of determining values of the detected digital bits, monitoring the determined values to recognize at least one code word, and determining the angular position of the rotor based upon the at least one recognized code word.

### BRIEF DESCRIPTION OF THE DRAWINGS

The foregoing and other features and advantages of the present invention will become apparent to one skilled in the art upon consideration of the following description of the invention and the accompanying drawings, in which:

FIG. 1 is a perspective view of a sensor constructed in accordance with a first example embodiment of the present invention; and

FIG. 2 is a schematic plan view of a second embodiment of the present invention.

### DESCRIPTION OF EMBODIMENTS

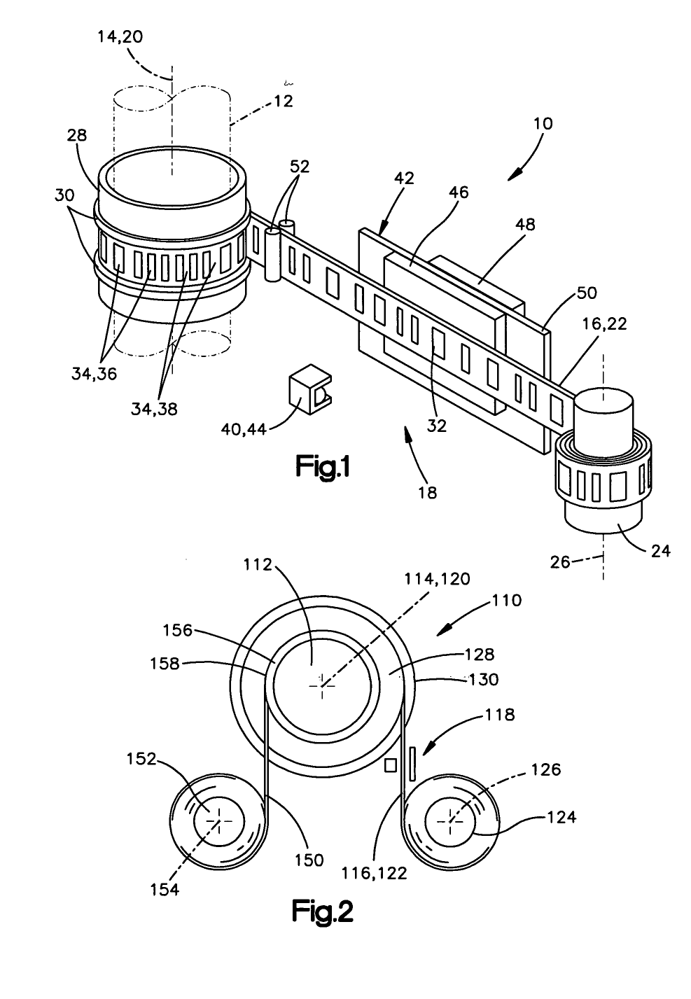

Referring to FIG. 1, an apparatus or sensor 10 is attached to a rotor 12, such as a steering shaft of a vehicle, for determining an angular position of the rotor, in accordance with an example of the present invention. A steering wheel (not shown) may be mounted on the rotor 12 for rotation with the rotor. The sensor 10 senses an angular position of the rotor 12 about a longitudinal rotor axis 14. The rotor 12 may rotate about the rotor axis 14 in each direction (e.g., clockwise and counter-clockwise) from an initial neutral or straight-ahead position. The rotor 12 may, for example, be rotatable through five complete rotations in each direction and thus rotate between −900° and +900°. Alternatively, the rotor may rotate through a greater or lesser number of complete or partial rotations and any number of degrees of rotation.

The sensor 10 includes an elongated member 16 and a detector 18. The elongated member 16 is attached to the rotor 12 so that the elongated member moves both lengthwise and in a direction transverse to the rotor axis 14 in response to rotation of the rotor. The detector 18 detects movement of the elongated member 16 in response to rotation of the rotor 12. The detected movement of the elongated member 16 is functionally related to the rotational position of the rotor 12.

The elongated member 16 of FIG. 1 is flexible so that it may wind and unwind about an axis 20, which may be coincident with the rotor axis 14, as shown in FIG. 1, or which may be offset from the rotor axis and may be either substantially parallel to or skewed with respect to the rotor axis. More specifically, the elongated member 16 of FIG. 1 is a length of tape 22, which is flat and which may be formed of spring metal or plastic. The use of spring metal, for example, causes the tape 22 to wind or coil up without the need for a winding mechanism and also helps to avoid buckling of the tape. The coiled tape 22 is mounted on a spool 24 that is rotatable about a spool axis 26. The spool axis 26 is substantially parallel to and is laterally offset from the rotor axis 14.

The end of the coiled tape 22 located adjacent to the outer circumference of the coil is attached to the rotor 12. Rotation of the rotor 12 thus causes the tape 22 to unwind or uncoil from the spool 24 and wind or coil about the rotor, the rotor axis 14, and the axis 20. The tape 22 is attached to the rotor 12 via a collar 28. The collar 28, which may be formed of metal or plastic, encircles the rotor 12 and is fixed to the rotor to rotate with the rotor. To help guide the tape 22 and ensure that the tape remains properly positioned, the collar 28 includes a pair of radially extending flanges 30 spaced apart along the length of the rotor. The tape 22 winds onto the collar 28 and thus the rotor 12 between the flanges 30.

Between the rotor 12 and the spool 24, the tape 22 extends along a substantially straight path. A selected portion 32 of the length of the tape 22 extends along the substantially straight path and is adjacent to the detector 18. The detector 18 detects movement of the selected portion 32 of the tape 22, which is functionally related to rotational movement of the rotor 12. The specific portion of the length of the tape 22 that constitutes the selected portion 32 changes as the rotational position of the rotor 12 changes and the tape correspondingly moves lengthwise.

To permit the detector 18 to detect movement of the tape 22, the tape includes indicia 34 along the length of the tape. The indicia 34 may include a plurality of discrete indicia spaced apart along the length of the tape 22. The indicia shown in FIG. 1 include a plurality of openings 36 and uninterrupted portions 38 of the material forming the tape, which effectively separate the openings 36 from one another. The openings 36 are rectangular in shape and, for clarity of illustration, are shown as being wider than they would typically be in use. Forms of indicia 34 other than openings 36 and uninterrupted portions 38 may be used as long as the detector 18 is capable of detecting the indicia.

The detector 18 of FIG. 1 includes a field source 40 for generating a field and a field effect detector 42. The field source 40 shown in FIG. 1 is a photo emitter or light source 44, such as a light emitting diode (LED). The field effect detector 42 shown in FIG. 1 includes a photo detector such as a photo sensor array 46 coupled to a microprocessor 48. The light source 44 is located on one side of the selected portion 32 of the length of the tape 22 and on one side of the substantially straight path along which the tape extends between the rotor 12 and the spool 24. The photo sensor array 46 is located on the opposite side of the selected portion 32 of the length of the tape 22 and the substantially straight path. When the light source 44 is actuated to generate a field and illuminate the selected portion 32 of the tape 22, light from the light source passes through the openings 36 in the selected portion of the tape and is blocked from passing through the uninterrupted portions 38 of the tape. The photo sensor array 46 detects the indicia 34, which include the openings 36 and the uninterrupted portions 38, as illuminated and non-illuminated areas.

The indicia 34 are arranged to provide a pseudo-random array of binary digits or bits (i.e., 1's and 0's) along the length of the tape 22 that can be detected and monitored by the detector 18. The pseudo-random array of bits forms a unique pattern for each of a multiplicity of predetermined designated segments along the length of the tape 22. Each unique pattern thus identifies a specific portion of the length of the tape 22. More specifically, with a rotor capable of rotating through five complete rotations in either direction from an initial neutral or straight-ahead position or between −900° and +900°, the length of the tape 22 may be divided into 2048 equally-sized predetermined designated segments. Each of the 2048 predetermined designated segments can be represented by a unique series of 11 bits, which form a unique digital code word.

As the tape 22 is wound around or unwound from the rotor 12, there is a corresponding lengthwise movement of the tape past the detector 18. In effect, one designated segment of the length of the tape 22 is initially adjacent to a predetermined measurement point at the detector 18, such as the center of the photo sensor array 46. Lengthwise movement of the tape brings another designated segment adjacent to the measurement point. Movement of the tape 22 that is just enough to shift from one designated segment to the next designated segment along the length of the tape will represent approximately 0.9° (nine-tenths of a degree) of rotation of the rotor (1800 degrees divided by 2048 designated segments). For exceptionally precise measurements, the correlation between the degrees of rotation of the rotor 12 and the lengthwise movement of the tape 22 may be adjusted to account for the varying effective diameter of the rotor perceived by the tape as it is wound around and unwound from the rotor.

As previously explained, when the light source 44 is actuated to illuminate the selected portion 32 of the tape 22, the photo sensor array 46 detects the indicia 34, which include the openings 36 and the uninterrupted portions 38, as illuminated and non-illuminated areas. The photo sensor array 46 detects digital bits from the illuminated and non-illuminated areas based on the sizes or widths of the areas. For example, a single bit may be represented by a width of eight pixels on the photo sensor array 46. A given illuminated or non-illuminated area may thus represent one or more than one digital bit. Digital one's (1's) may be represented by illuminated areas on the photo sensor array 46 and digital zero's (0's) may be represented by non-illuminated areas. The photo sensor array 46 transmits the digital bits detected from illumination of the selected portion 32 of the length of the tape 22 to a microprocessor 48. The microprocessor 48 may be mounted at any location in the sensor 10, such as on a printed circuit board (PCB) 50 together with the photo sensor array 46.

The microprocessor 48 monitors the detected digital bits, including their sequence or order, from the photo sensor array 46 to recognize one or more digital code words from the detected bits. From the recognized code word or words, the microprocessor 48 can determine which designated segment along the length of the tape 22 is adjacent to the predetermined measurement point on the photo sensor array 46. From this determination, the microprocessor 48 can determine the relative longitudinal position of the tape 22 and, in turn, the rotational position of the rotor 12. The microprocessor 48 can make these determinations by performing one or more algorithms and/or using one or more look-up tables. The determined rotational position of the rotor 12 can be provided to other systems, controllers, and/or microprocessors via a communications bus, for example, or to other algorithms to be performed by the microprocessor 48, as may be required.

In one embodiment of the invention, it may be desirable to package various elements described above in a module. Such a module may, for example, include the tape 22, the field source 40 and the field effect detector 42 and also the collar 28 and the spool 24. The module may have a housing (not shown), which may be formed of a plastic material, to enclose the foregoing module components. The housing may be formed with an opening to receive the rotor 12.

In one example embodiment of the sensor 10, the distance between the light source 44 and the photo sensor array 46 may range from about 2.5 to about 12 millimeters (mm) or, more particularly, from about 4 to about 5 mm. The outer diameter of the rotor 12 and the inner diameter of the collar 28 may be about 35 mm. The thickness of the tape 22 may be about 0.1 mm. The length of an individual bit as represented by the indicia 34 on the tape 22 may be about 0.3 mm. The length of the photo sensor array 46 may range from about 7.5 mm to about 8.5 mm. The number of pixels on the photo sensor array 46 may range from about 128 to about 256, and the pixel pitch or distance between the pixels may range from about 0.032 mm to about 0.070 mm. The number of pixels per digital bit may, therefore, range from about 4 to about 10. One skilled in the art will appreciate that the foregoing and other numerical values set forth herein are given by way of example only and that other values may be used and other resolutions may result.

The functioning or operation of the sensor 10 may be enhanced in various ways. For example, the photo sensor array 46 may only need to detect a number of digital bits corresponding to the length of a single code word identifying a predetermined designated segment along the length of the tape 22. If the photo sensor array 46 is made larger or otherwise enabled to detect more digital bits, however, the photo sensor array may be capable of recognizing code words for designated segments adjacent to the designated segment located at the predetermined measurement point. Having the capability for recognizing more than one code word provides an increased level of robustness for the sensor 10. Specifically, if the value of one or more digital bits cannot be determined due, for example, to dirt or dust on the photo sensor array 46, the detector 18 may nonetheless be able to identify the designated segment located at the predetermined measurement point based on the two or more partial code words that can be recognized. The microprocessor 48 may, for example, include a memory unit containing a look-up table with all of the code words used on the tape 22 and the order of their use along the length of the tape. The code words that include the recognized partial code words and that identify designated segments adjacent to one another on the tape 22 may be identified by reviewing such a look-up table. This process may then lead to identification of the specific designated segment at the predetermined measurement point.

Similarly, the photo sensor array 46 may only need a single linear array of pixels to detect the digital bits represented by the indicia 34. Additional linear arrays of pixels may be used to provide redundancy and an increased level of robustness for the sensor 10. For example, the individual linear arrays of pixels may be monitored separately by the microprocessor 48 and the digital bits detected by the individual linear arrays of pixels may be compared. Such a comparison may help detect defective or obstructed pixels and other fault conditions.

The functioning of the sensor 10 may also be enhanced by pulsing the light source 44 ON and OFF at a desired frequency to provide a pulse-width-modulated signal at the photo sensor array 46. If the light source 44 is strobed ON and OFF in synchronization with the rate at which the photo sensor array 46 is capable of detecting the illuminated and non-illuminated areas produced by the indicia 34, the photo sensor array may be able to detect the digital bits represented by the illuminated and non-illuminated areas at a faster effective rate without corrupting the detection results.

The functioning of the sensor 10 may further be enhanced by using a photo sensor array 46 with smaller pixels, which may allow a reduction in the width of the indicia 34 necessary to represent one digital bit. If the indicia 34 are more narrow, more indicia may be used on any given length of the tape 22, which may allow more and smaller designated segments and a more refined or precise determination of rotational position of the rotor 12. Alternatively, movement of the indicia 34 and thus the digital bits across the photo sensor array 46 may be detected at the individual pixel level, which may increase the precision of the determination of the rotational position of the rotor 12.

Still further, the functioning of the sensor 10 may be enhanced by maintaining the tape 22 as flat as possible as it passes the photo sensor array 46, as close to the photo sensor array as possible, and as nearly parallel to the photo sensor array as possible. Guides 52, which may be arranged in pairs, may help to keep the tape 22 substantially flat and/or close to the photo sensor array 46 and/or parallel to the photo sensor array 46. Although only two such guides 52 are shown in FIG. 1, additional guides may be used as desired. If the sensor 10 is packaged in a module housing, such guides 52 may be incorporated into the module housing.

A sensor 110 constructed in accordance with a second embodiment of the present invention is illustrated in FIG. 2. The second embodiment is generally similar to the embodiment of FIG. 1. The sensor 110 includes an elongated member 116 and a detector 118. The elongated member 116 is attached to a rotor 112 so that the elongated member moves lengthwise in response to rotation of the rotor. The elongated member 116 is flexible so that it may wind and unwind about an axis 120, which may be coincident with a rotor axis 114, as shown in FIG. 2.

The elongated member 116 shown in FIG. 2 is a length of tape 122, which is flat and which may be formed of spring metal or plastic. The use of spring metal, for example, causes the tape 122 to wind or coil up without the need for a winding mechanism and also helps to avoid buckling of the tape. The coiled tape 122 is positioned on a spool 124 that is rotatable about a spool axis 126. The spool axis 126 is substantially parallel to and is laterally offset from the rotor axis 114.

The end (not shown) of the tape 122 located adjacent the outer circumference of the coil is attached to the rotor 112. Rotation of the rotor 112 thus causes the tape 122 to unwind or uncoil from the spool 124 and wind or coil about the rotor, the rotor axis 114, and the axis 120. The tape 122 is attached to the rotor 112 via a collar 128. The collar 128, which may be formed of metal or plastic, encircles the rotor 112 and is fixed to the rotor to rotate with the rotor. To help guide the tape 122 and ensure that the tape remains properly positioned, the collar 128 includes a pair of radially extending flanges 130 spaced apart along the length of the rotor. The tape 122 winds onto the collar 128 and thus the rotor 112 between the flanges 130.

To help balance the load imposed on the rotor 112 by the tape 122, a second, similar tape 150 is attached to the rotor so as to wind about and unwind from the rotor 112 in an opposite direction from the tape 122 or in opposition to the winding and unwinding of the tape 122. Like the tape 122, the second tape 150 may be formed of spring metal or plastic, which causes the second tape 150 to wind or coil up without the need for a winding mechanism and also helps to avoid buckling of the tape. The coiled second tape 150 is positioned on a second spool 152 that is rotatable about a second spool axis 154. The second spool axis 154 is substantially parallel to and is laterally offset from the rotor axis 114.

The end (not shown) of the second tape 150 located adjacent the outer circumference of the coil is attached to the rotor 112. Rotation of the rotor 112 thus causes the second tape 150 to unwind or uncoil from the spool 152 and wind or coil about the rotor, the rotor axis 114, and the axis 120. The tape 122 is attached to the rotor 112 via a second collar 156. The second collar 156, which may be formed of metal or plastic, encircles the rotor 112 and is fixed to the rotor to rotate with the rotor. To help guide the tape 122 and ensure that the tape remains properly positioned, the second collar 156 includes a pair of radially extending flanges 158 spaced apart along the length of the rotor. The tape 122 winds onto the second collar 156 and thus the rotor 112 between the flanges 158.

As previously noted, although the indicia 34 of FIG. 1 are formed as openings 36 and uninterrupted portions 38 of the material forming the tape 22, forms of indicia 34 other than openings 36 and uninterrupted portions 38 may be used as long as the detector 18 is capable of detecting the indicia. For example, the indicia 34 may also be formed as opaque and transparent segments of a plastic tape, such as Mylar® tape, rather than as openings 36 and uninterrupted portions 38 of a metal or other tape. Alternatively, the indicia 34 may include reflective and non-reflective areas on the tape 22. Use of such reflective indicia 34 would permit the light source 44 and the photo sensor array 46 to be located on the same side of the tape 22 and on the same side of the substantially straight path along which the tape extends between the spool 24 and the rotor 12. The light source 44 for illuminating such indicia 34 may, however, require an appropriate lens, for example, to help prevent the light from the light source radiating in a wide beam. Use of reflective and non-reflective indicia 34 may also permit the use of an ultrasonic field generation source and an ultrasonic detector in place of the light source 44 and photo sensor array 46, respectively.

Still further, the indicia 34 may be formed as metalized and non-metalized portions of a plastic tape, such as Mylar® tape, and the detector 18 may include a magnet, rather than a light source 44, and an array of Hall-effect sensors, rather than a photo sensor array 46. Passage of the tape 22 with such indicia 34 between the magnet and the array of Hall-effect sensors would cause the array of Hall-effect sensors to detect the indicia 34.

As also previously noted, the axis 20 about which the tape 22 winds and unwinds may be offset from the rotor axis 14 and may be either substantially parallel to or skewed with respect to the rotor axis. If the axis 20 is offset from the rotor axis 14, a linkage may be provided to transmit rotational movement of the rotor 12 to the collar 28 or other element on which the tape 22 is wound and from which the tape is unwound. Such a linkage may, for example, include a gear train.

From the above description of the invention, those skilled in the art will perceive improvements, changes and modifications. For example, the field source 40 of FIG. 1 is shown and described as an LED located adjacent to the tape 22, but any source of light may be used. The light source 44 may also be located remotely from the photo sensor array 46 with light being transmitted via, for example, an optical fiber, to a location for illuminating the tape 22. Such improvements, changes and modifications within the skill of the art are intended to be covered by the appended claims.

Having described the invention, the following is claimed:

1. A sensor for determining an angular position of a rotor, said sensor comprising:
an elongated member for attachment to the rotor for lengthwise movement in response to rotation of the rotor, the elongated member having a length and including indicia identifying predetermined designated segments along said length;
a field source for generating a field adjacent to a selected portion of said length of the elongated member; and
a field effect detector for detecting at least one of said indicia associated with said selected portion of said length of the elongated member in response to generation of said field adjacent to said selected portion, said detected at least one of said indicia identifying at least one of said designated segments, said at least one identified designated segment being functionally related to the angular position of said rotor.

2. A sensor according to claim 1 wherein said selected portion of said length of the elongated member extends along a substantially straight path.

3. A sensor according to claim 2 wherein said field source is located on one side of said substantially straight path and said field effect detector is located on an opposite side of said substantially straight path.

4. A sensor according to claim 1 wherein the elongated member is flexible.

5. A sensor according to claim 4 wherein the elongated member winds and unwinds about an axis substantially parallel to a rotor axis about which the rotor rotates.

6. A sensor according to claim 5 wherein the axis about which the elongated member winds and unwinds is coincident with the rotor axis.

7. A sensor according to claim 5 wherein the elongated member also winds and unwinds about a spool axis substantially parallel to and spaced laterally from said rotor axis.

8. A sensor according to claim 7 wherein said elongated member is a first elongated member and said spool axis is a first spool axis and wherein said sensor further comprises a second flexible elongated member that winds and unwinds about an axis substantially parallel to the rotor axis about which the rotor rotates and also winds and unwinds about a second spool axis substantially parallel to and spaced laterally from said rotor axis and said first spool axis, said second elongated member winding and unwinding in opposition to the winding and unwinding of the first elongated member.

9. A sensor according to claim 1 wherein said indicia include openings in the elongated member.

10. A sensor according to claim 1 where said indicia include reflective portions of the elongated member.

11. A sensor according to claim 1 wherein the elongated member is flat.

12. A sensor according to claim 1 wherein said field source is a light source.

13. A sensor according to claim 1 wherein said field effect detector is a photo detector.

14. A sensor for determining an angular position of a rotor, said sensor comprising:
an elongated member for attachment to the rotor for lengthwise movement in response to rotation of the rotor, the elongated member having a length and including indicia identifying predetermined designated segments along said length;
a light source for illuminating a selected portion of said length of the elongated member; and
a detector for detecting at least one of said indicia associated with said selected portion of said length of the elongated member in response to illumination of said selected portion by said light source, said detected at least one of said indicia identifying at least one of said designated segments, said at least one identified designated segment being functionally related to the angular position of said rotor.

15. A sensor according to claim 14 wherein said selected portion of the elongated member extends along a substantially straight path.

16. A sensor according to claim 15 wherein said light source is located on one side of said substantially straight path and said detector is located on an opposite side of said substantially straight path.

17. A sensor according to claim 14 wherein the elongated member is flexible.

18. A sensor according to claim 17 wherein the elongated member winds and unwinds about an axis substantially parallel to a rotor axis about which the rotor rotates.

19. A sensor according to claim 18 wherein the axis about which the elongated member winds and unwinds is coincident with the rotor axis.

20. A sensor according to claim 18 wherein the elongated member also winds and unwinds about a spool axis substantially parallel to and spaced laterally from said rotor axis.

21. A sensor according to claim 20 wherein said elongated member is a first elongated member and said spool axis is a first spool axis and wherein said sensor further comprises a second flexible elongated member that winds and unwinds about an axis substantially parallel to the rotor axis about which the rotor rotates and also winds and unwinds about a second spool axis substantially parallel to and spaced laterally from said rotor axis and said first spool axis, said second elongated member winding and unwinding in opposition to the winding and unwinding of the first elongated member.

22. A sensor according to claim 14 wherein said indicia include openings in the elongated member.

23. A sensor according to claim 14 where said indicia include reflective portions of the elongated member.

24. A sensor according to claim 14 wherein the elongated member is flat.

25. An apparatus for determining an angular position of a rotor, said apparatus comprising:
an elongated member for attachment to the rotor for lengthwise movement in response to rotation of the rotor, the elongated member having a length and including indicia representing digital bits to identify predetermined designated segments along said length, each designated segment being identified by a code word comprising a plurality of digital bits; and
a detector for detecting the digital bits from a selected portion of said length of the elongated member, said selected portion of said length being functionally related to the angular position of said rotor, said detector determining values of the detected digital bits, monitoring the determined values to recognize at least one code word, and determining the angular position of the rotor based upon the at least one recognized code word.

26. An apparatus according to claim 25 wherein said selected portion of said length of the elongated member extends along a substantially straight path.

27. An apparatus according to claim 25 wherein the elongated member is flexible.

28. An apparatus according to claim 27 wherein the elongated member winds and unwinds about an axis substantially coincident with a rotor axis about which the rotor rotates.

29. An apparatus according to claim 28 wherein the axis about which the elongated member winds and unwinds is coincident with the rotor axis.

30. An apparatus according to claim 28 wherein the elongated member also winds and unwinds about a spool axis substantially parallel to and spaced laterally from said rotor axis.

31. An apparatus according to claim 30 wherein said elongated member is a first elongated member and said spool axis is a first spool axis and wherein said apparatus further comprises a second flexible elongated member that winds and unwinds about an axis substantially parallel to the rotor axis about which the rotor rotates and also winds and unwinds about a second spool axis substantially parallel to and spaced laterally from said rotor axis and said first spool axis, said second elongated member winding and unwinding in opposition to the winding and unwinding of the first elongated member.

32. An apparatus according to claim 25 wherein said indicia include openings in the elongated member.

33. An apparatus according to claim 25 where said indicia include reflective portions of the elongated member.

34. An apparatus according to claim 25 wherein the elongated member is flat.

35. A method for determining an angular position of a rotor, said method comprising the steps of:
attaching an elongated member to the rotor for lengthwise movement in response to rotation of the rotor, the elongated member having a length and including indicia identifying predetermined designated segments along said length;
generating a field adjacent to a selected portion of said length of the elongated member, said selected portion of the length being functionally related to the angular position of the rotor;
detecting at least one of said indicia associated with said selected portion of said length of the elongated member in response to generation of said field adjacent to said selected portion;
identifying at least one of said designated segments from said detected at least one of said indicia; and
determining the angular position of the rotor based upon the identified at least one of said designated segments.

36. A method for determining an angular position of a rotor, said method comprising the steps of:
attaching an elongated member to the rotor for lengthwise movement in response to rotation of the rotor, the elongated member having a length and including indicia representing digital bits to identify predetermined designated segments along said length, each designated segment being identified by a code word comprising a plurality of digital bits;
detecting the digital bits from a selected portion of the length of the elongated member, said selected portion of the length being functionally related to the angular position of the rotor;
determining values of the detected digital bits;
monitoring the determined values to recognize at least one code word; and
determining the angular position of the rotor based upon the at least one recognized code word.
